(19) United States
(12) Patent Application Publication
(10) Pub. No.: US 2026/0005439 A1
(43) Pub. Date: Jan. 1, 2026

(54) Antenna Structure and Electronic Device

(71) Applicant: Huawei Technologies Co., Ltd., Shenzhen, Guangdong (CN)

(72) Inventors: Bingbo Xu, Shenzhen (CN); Liwan Zhang, Xi'an (CN); Liang Lu, Xi'an (CN); Pengfei Wu, Shanghai (CN); Kun Feng, Shanghai (CN); Xinpeng Chen, Xi'an (CN)

(73) Assignee: Huawei Technologies Co., Ltd., Shenzhen, Guangdong (CN)

(21) Appl. No.: 19/322,136

(22) Filed: Sep. 8, 2025

Related U.S. Application Data
(63) Continuation of application No. PCT/CN2024/078013, filed on Feb. 22, 2024.

(30) Foreign Application Priority Data
Mar. 31, 2023 (CN) 202310380813.7

(51) Int. Cl. H01Q 5/50; H01Q 1/24; H01Q 5/20; H01Q 7/00

(52) U.S. Cl. CPC H01Q 5/50; H01Q 1/243; H01Q 7/00; H01Q 5/20

(57) ABSTRACT

An antenna structure includes a first radiator, a second radiator, a transmission line, a feed point, and a ground point. A first end of the transmission line is electrically connected to the feed point, a second end of the transmission line is electrically connected to both the first radiator and the second radiator, and the first radiator is electrically connected to the ground point. In addition, an impedance of the first radiator in a first state and an impedance of the second radiator in a second state are conjugated, the transmission line separately transmits electromagnetic energy to the first radiator in the first state, and the transmission line separately transmits electromagnetic energy to the second radiator in the second state.

### CROSS-REFERENCE TO RELATED APPLICATIONS

This is a continuation of International Patent Application No. PCT/CN2024/078013, filed on Feb. 22, 2024, which claims priority to Chinese Patent Application No. 202310380813.7, filed on Mar. 31, 2023, both of which are incorporated by reference.

### TECHNICAL FIELD

This disclosure relates to the field of antenna technologies, and in particular, to an antenna structure and an electronic device.

### BACKGROUND

An antenna is a device that converts energy and directionally radiates or receives an electromagnetic wave in wireless communication, and is widely used in engineering systems such as radio communication, broadcasting, radars, navigation, and remote sensing. For example, the antenna is used in an electronic device like a mobile phone, a notebook computer, a tablet computer, a netbook, or a wearable device, and the electronic device may implement signal transmission through the antenna.

For example, the antenna is used in a mobile phone. Currently, in most mobile phones, a metal side frame or a camera decorative part on a rear cover is separately used as an antenna, to transmit and receive signals. However, in the foregoing disposing manner, an antenna coverage area is small, antenna system efficiency is low, and a bandwidth is narrow. Consequently, communication reliability of the electronic device is reduced.

### SUMMARY

This disclosure provides an antenna structure and an electronic device, to resolve problems of a small antenna coverage area, low antenna system efficiency, and a narrow bandwidth of an existing electronic device.

A first aspect of this disclosure provides an antenna structure, including a first radiator, a second radiator, a transmission line, a feed point, and a ground point.

A first end of the transmission line is electrically connected to the feed point, a second end of the transmission line is electrically connected to both the first radiator and the second radiator, and the first radiator is electrically connected to the ground point.

In addition, an impedance of the first radiator in a first state and an impedance of the second radiator in a second state are conjugated, the transmission line separately transmits electromagnetic energy to the first radiator in the first state, and the transmission line separately transmits electromagnetic energy to the second radiator in the second state.

In this disclosure, the first radiator and the second radiator are electrically connected through the transmission line, and an impedance of the first radiator in a single-pass state and an impedance of the second radiator in a single-pass state are conjugated. In this way, when the transmission line simultaneously transmits electromagnetic energy to the first radiator and the second radiator, an electromagnetic wave signal is radiated outward through both the first radiator and the second radiator. In this case, load impedances of the first radiator and the second radiator may adapt to each other, allowing their modes to integrate, and a radiation bandwidth of the electromagnetic wave signal can be effectively increased. In this way, radiation intensity of the antenna structure in a wide frequency band is effectively increased, and communication reliability and stability of the electronic device are improved.

In addition, the first radiator and the second radiator simultaneously transmit and receive signals, so that signal strength and a coverage area of the antenna structure can be further effectively increased, and the antenna structure can transmit and receive electromagnetic wave signals in a plurality of directions. This effectively improves communication reliability of the electronic device.

In a possible implementation, two matching circuits are further included. One end of one of the two matching circuits is electrically connected to the second end of the transmission line, and the other end is electrically connected to the first radiator. One end of the other of the two matching circuits is electrically connected to the second end of the transmission line, and the other end is electrically connected to the second radiator. The matching circuits may adjust the impedances of the first radiator and the second radiator, so that the impedances of the first radiator and the second radiator in the single-pass states can be conjugated, and the load impedances can adapt to each other in a state in which the first radiator and the second radiator work simultaneously. In this way, the transmit working modes of the first radiator and the second radiator can integrate, so that the radiation bandwidth of the electromagnetic wave signal is effectively increased, and the radiation intensity of the antenna structure in the wide frequency band is increased.

In a possible implementation, each matching circuit includes a first circuit, or subcircuit, and the first circuit includes at least one of a first capacitor and a first inductor. In addition, when the first circuit includes the first inductor and the first capacitor, the first inductor and the first capacitor are connected in series. One end of the first circuit is electrically connected to the second end of the transmission line, and the other end of the first circuit is electrically connected to the first radiator or the second radiator. The first inductors and the first capacitors in the two first circuits may adjust imaginary parts of the impedances of the first radiator and the second radiator respectively, so that the impedances of the first radiator and the second radiator in the single-pass states can be conjugated. In this way, the first radiator and the second radiator can adapt to each other in the state in which the first radiator and the second radiator work simultaneously.

In a possible implementation, each matching circuit further includes a second circuit, and the second circuit, or subcircuit, includes at least one of a second capacitor and a second inductor. In addition, when the second circuit includes the second inductor and the second capacitor, the second inductor and the second capacitor are connected in series. One end of the second circuit is electrically connected to the first circuit, and the other end of the second circuit is grounded. The second inductor and the second capacitor may implement impedance matching between the second circuit and a metal middle plate, to improve efficiency of transmitting an electromagnetic wave signal between the second circuit and the metal middle plate.

In a possible implementation, the transmission line includes a main line, a first branch line, and a second branch line. The feed point is electrically connected to a first end of the main line. One end of the first branch line is electrically connected to a second end of the main line, and the other end of the first branch line is electrically connected to the first radiator. One end of the second branch line is electrically connected to the second end of the main line, the other end of the second branch line is electrically connected to the second radiator, and the first branch line and the second branch line are spaced apart along a length of the main line. The two matching circuits are connected in series to the first branch line and the second branch line respectively.

In a possible implementation, a connection post is further included. One end of the connection post is electrically connected to the first radiator, and the other end of the connection post is electrically connected to the second end of the transmission line, so that the first radiator is electrically connected to the second end of the transmission line through the connection post.

In a possible implementation, at least one ground post is further included. One end of the ground post is electrically connected to the first radiator, and the other end of the ground post is electrically connected to the ground point.

In a possible implementation, there are two ground posts, the two ground posts are a first ground post and a second ground post, and there are two ground points.

One end of the first ground post and one end of the second ground post are electrically connected to the first radiator, and the other end of the first ground post and the other end of the second ground post are electrically connected to the two ground points respectively.

In a possible implementation, a connection line between the two ground posts passes through a center of the first radiator, and is perpendicular to a connection line between the center of the first radiator and a connection point between the first radiator and the transmission line.

In a possible implementation, the first radiator is of a ring structure.

The second radiator is of a strip structure.

A second aspect of this disclosure provides an electronic device, including a middle frame, a display, a rear cover, and the antenna structure according to any one of the foregoing implementations. The middle frame is located between the display and the rear cover, and the first radiator of the antenna structure is located on the rear cover or located between the middle frame and the rear cover. The second radiator of the antenna structure is located on the middle frame.

The electronic device includes the foregoing antenna structure, so that communication reliability and stability of the electronic device can be effectively improved.

In a possible implementation, the middle frame includes a metal side frame, and at least a part of the metal side frame forms the second radiator of the antenna structure.

In a possible implementation, the middle frame further includes a metal middle plate, the metal middle plate is connected to the metal side frame, and the ground point of the antenna structure is electrically connected to the metal middle plate.

In a possible implementation, a camera decorative part is disposed on the rear cover, the camera decorative part is a metal part, and the camera decorative part forms the first radiator of the antenna structure.

### BRIEF DESCRIPTION OF DRAWINGS

FIG. 1 is a diagram of a structure of an electronic device according to an embodiment of this disclosure.

FIG. 2 is an exploded view of an electronic device according to an embodiment of this disclosure.

FIG. 3 is a main view of a first type of antenna structure according to an embodiment of this disclosure.

FIG. 4 is a diagram of a structure of a first type of antenna structure according to an embodiment of this disclosure.

FIG. 5 is a diagram of a structure of a second type of antenna structure according to an embodiment of this disclosure.

FIG. 6 is a diagram of a structure in which two ground posts are disposed on a first radiator according to an embodiment of this disclosure.

FIG. 7 is a diagram of a structure in which a matching circuit is disposed in an antenna structure according to an embodiment of this disclosure.

FIG. 8 is a diagram of a structure of a matching circuit according to an embodiment of this disclosure.

FIG. 9 is a diagram of a structure of another matching circuit according to an embodiment of this disclosure.

FIG. 10 is a diagram of a structure of a transmission line according to an embodiment of this disclosure.

FIG. 11 is a main view of a first radiator according to an embodiment of this disclosure.

FIG. 12 is a top view of a first radiator according to an embodiment of this disclosure.

FIG. 13 is a diagram of a structure of a second radiator according to an embodiment of this disclosure.

FIG. 14 is a diagram of a size of a transmission line according to an embodiment of this disclosure.

FIG. 15 is a diagram of a structure of a connection post according to an embodiment of this disclosure.

FIG. 16 is a diagram of a return loss of a first type of antenna structure according to an embodiment of this disclosure.

FIG. 17 is a diagram of radiation efficiency of a first type of antenna structure according to an embodiment of this disclosure.

FIG. 18 is a diagram of a return loss of a second type of antenna structure according to an embodiment of this disclosure.

FIG. 19 is a diagram of radiation efficiency of a second type of antenna structure according to an embodiment of this disclosure.

FIG. 20 is a Smith chart of a first radiator in a single-pass state according to an embodiment of this disclosure.

FIG. 21 is a Smith chart of a second radiator in a single-pass state according to an embodiment of this disclosure.

### DETAILED DESCRIPTION

Terms used in embodiments of this disclosure are merely used to explain specific embodiments of this disclosure, but are not intended to limit this disclosure.

Embodiments of this disclosure provide an antenna structure and an electronic device including the antenna structure. The electronic device may be an electronic device having an antenna, for example, a mobile phone, a tablet computer, a notebook computer, an ultra-mobile personal computer (UMPC), a handheld computer, a walkie-talkie, a netbook, a point-of-sale (POS) terminal, or a personal digital assistant (PDA), a wearable device, a virtual reality device, or a vehicle-mounted apparatus.

In embodiments of this disclosure, an example in which the electronic device is a mobile phone is used. The mobile phone may be a bar phone or a foldable phone. Specifically, the following uses an example in which the electronic device is a bar phone for description.

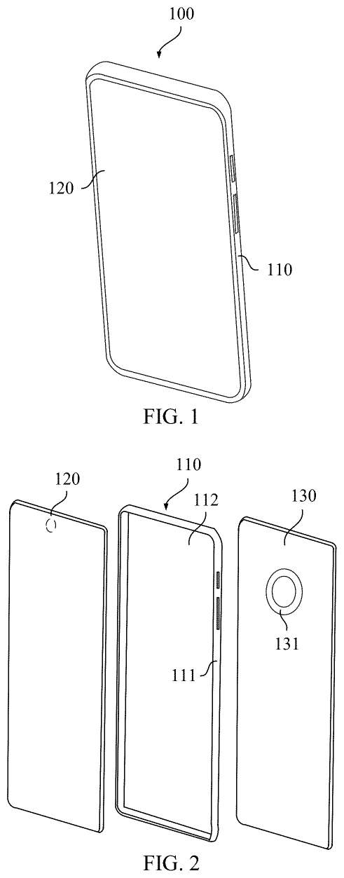

FIG. 1 is a diagram of a structure of an electronic device according to an embodiment of this disclosure. FIG. 2 is an exploded view of the electronic device according to an embodiment of this disclosure.

As shown in FIG. 1 and FIG. 2, the electronic device 100 may include a middle frame 110, a display 120, and a rear cover 130. The middle frame 110 may be located between the display 120 and the rear cover 130. For example, the display 120 and the rear cover 130 may be disposed on two opposite sides of the middle frame 110 respectively. The middle frame 110 may be configured to support and carry the display 120. The display 120 may be configured to display an image, for example, may display status information, battery level information, time, a video, a picture, and a short message service (SMS) message of the electronic device 100. The rear cover 130 may package components inside the electronic device 100, so that the electronic device 100 functions as a unified whole.

A camera decorative part 131 may be further disposed on the rear cover 130 of the electronic device 100. The camera decorative part 131 may be configured to decorate a camera, to improve overall aesthetics of the camera. The middle frame 110 of the electronic device 100 may include a metal side frame 111. The camera decorative part may be separately used as an antenna of the electronic device, to transmit and receive signals. Alternatively, the metal side frame is separately used as an antenna, to transmit and receive signals. However, a coverage area of the antenna is small, thereby reducing radiation efficiency of the antenna. Consequently, communication reliability and stability of the electronic device are affected.

Based on the foregoing problem, the antenna structure includes a first radiator and a second radiator, and impedances of the first radiator and the second radiator in separate working states are conjugated, so that load impedances of the two radiators can adapt to each other when the two radiators work simultaneously, allowing transmit or receive modes of the two radiators to integrate, to increase a radiation bandwidth of an electromagnetic wave signal, and increase radiation intensity of the antenna structure in a wide frequency band. This effectively improves communication reliability and stability of the electronic device.

The following describes in detail the antenna structure provided in embodiments of this disclosure with reference to the accompanying drawings.

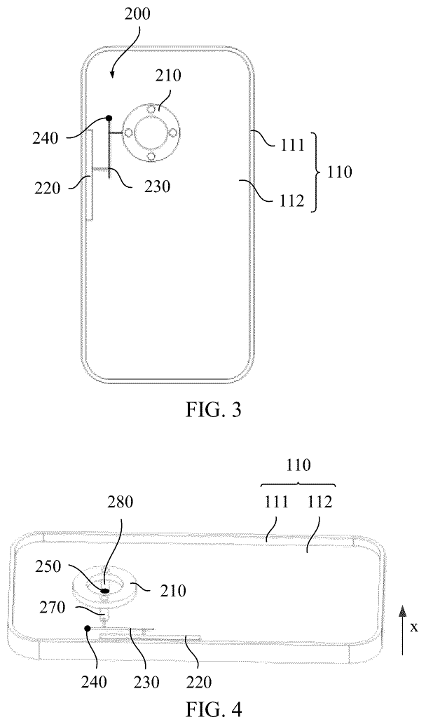

FIG. 3 is a main view of a first type of antenna structure according to an embodiment of this disclosure. FIG. 4 is a diagram of a structure of the first type of antenna structure according to an embodiment of this disclosure.

As shown in FIG. 3 and FIG. 4, an embodiment of this disclosure provides an antenna structure 200. The antenna structure 200 may include a first radiator 210, a second radiator 220, a transmission line 230, a feed point 240, and a ground point 250. A first end of the transmission line 230 may be electrically connected to the feed point 240, and a second end of the transmission line 230 may be electrically connected to both the first radiator 210 and the second radiator 220. It should be noted that the second end of the transmission line 230 may not be understood as a point in a narrow sense, and may alternatively be considered as a segment that is of the transmission line 230 and that includes an endpoint of the transmission line 230.

The feed point 240 may feed or input power to the transmission line 230, so that electromagnetic energy at the feed point 240 may be transmitted to both the first radiator 210 and the second radiator 220 through the transmission line 230, and an electromagnetic wave signal is radiated outward through both the first radiator 210 and the second radiator 220. For example, the feed point 240 may be electrically connected to a radio frequency unit (not shown in the figure) in the electronic device 100. Electromagnetic energy emitted by the radio frequency unit may be transmitted to the feed point 240, and then transmitted to the first radiator 210 and the second radiator 220 through the feed point 240.

For example, the first radiator 210 may be located on the rear cover 130 of the electronic device 100, or may be located between the middle frame 110 and the rear cover 130 of the electronic device 100. For example, the camera decorative part 131 of the electronic device 100 may be a metal part. In this case, the camera decorative part 131 may form the first radiator 210. Alternatively, when the camera decorative part 131 is a non-metal part, a metal structure may be disposed between the rear cover 130 and the middle frame 110, so that the metal structure can form the first radiator 210.

The second radiator 220 may be located on the middle frame 110 of the electronic device 100. For example, the middle frame 110 of the electronic device 100 may include a metal side frame 111, and at least a part of the metal side frame 111 may form the second radiator 220 of the antenna structure 200. Alternatively, when the middle frame 110 of the electronic device 100 is of a non-metal structure, a metal mechanical part may be disposed on the middle frame 110, so that the metal mechanical part can form the second radiator 220.

The first radiator 210 is further electrically connected to the ground point 250. For example, the middle frame 110 of the electronic device 100 may further include a metal middle plate 112, the metal middle plate 112 may be connected to the metal side frame 111, and the ground point 250 of the antenna structure 200 may be electrically connected to the metal middle plate 112. In this way, an electromagnetic wave signal on the first radiator 210 may be further transmitted to the metal middle plate 112 through the ground point 250, so that the electromagnetic wave signal can be transmitted outward through the metal middle plate 112, to improve propagation strength of the electromagnetic wave signal.

An impedance of the first radiator 210 in a first state and an impedance of the second radiator 220 in a second state are conjugated. The transmission line 230 separately transmits electromagnetic energy to the first radiator 210 in the first state, and the transmission line 230 separately transmits electromagnetic energy to the second radiator 220 in the second state. For example, when the antenna structure 200 is in the first state, the second radiator 220 may be disconnected from the transmission line 230, so that the transmission line 230 can separately feed the first radiator 210. In other words, the first radiator 210 is in a single-pass state. In this case, the impedance of the first radiator 210 may be obtained. When the antenna structure 200 is in the second state, the first radiator 210 may be disconnected from the transmission line 230, so that the transmission line 230 separately feeds the second radiator 220. In other words, the second radiator 220 is in a single-pass state. In this case, the impedance of the second radiator 220 may be obtained. The impedance is in a complex number form, and includes a real part and an imaginary part. When the impedance of the first radiator 210 in the single-pass state and the impedance of the second radiator 220 in the single-pass state are conjugated, real parts of the impedance of the first radiator 210 and the impedance of the second radiator 220 are equal, and imaginary parts of the impedance of the first radiator 210 and the impedance of the second radiator 220 are opposite numbers to each other.

In comparison with the manner in which the camera decorative part and the metal side frame are separately used as the antenna, in this embodiment of this disclosure, the first radiator 210 and the second radiator 220 are electrically connected through the transmission line 230, and the impedance of the first radiator 210 in the single-pass state and the impedance of the second radiator 220 in the single-pass state are conjugated. In this way, when the transmission line 230 simultaneously feeds the first radiator 210 and the second radiator 220, the electromagnetic wave signal is radiated outward through both the first radiator 210 and the second radiator 220. In this case, load impedances of the first radiator 210 and the second radiator 220 may adapt to each other, allowing their modes to integrate, and a radiation bandwidth of the electromagnetic wave signal can be effectively increased. In this way, radiation intensity of the antenna structure 200 in a wide frequency band is effectively increased, and communication reliability and stability of the electronic device 100 are improved.

In addition, the first radiator 210 and the second radiator 220 simultaneously transmit and receive signals, so that signal strength and a coverage area of the antenna structure 200 can be further effectively increased, and the antenna structure 200 can transmit and receive electromagnetic wave signals in a plurality of directions. This effectively improves communication reliability of the electronic device 100.

In this embodiment of this disclosure, for an electrical connection between any two mechanical parts, for example, an electrical connection between the transmission line 230 and the feed point 240, the electrical connection between the transmission line 230 and the feed point 240 may be an electrical connection performed through a metal spring. Alternatively, the transmission line 230 may be electrically connected to the feed point 240 through welding. Alternatively, in some examples, the transmission line 230 may be electrically connected to the feed point 240 through electrical coupling. A manner of the electrical connection between the transmission line 230 and the feed point 240 is not limited in embodiments of this disclosure, provided that the electromagnetic wave signal can be transmitted between the transmission line 230 and the feed point 240.

Correspondingly, an electrical connection relationship between any two mechanical parts in this embodiment of this disclosure may be implemented through a metal spring, welding, or electrical coupling. Details are not described herein again.

Still referring to FIG. 4 and in this embodiment of this disclosure, the first radiator 210 may be of a ring structure. For example, when the first radiator 210 is disposed on the rear cover 130 of the electronic device 100, the first radiator 210 may be disposed around the camera, to decorate the camera. For example, the first radiator 210 may be of a circular ring structure. Alternatively, in some examples, the first radiator 210 may be of a rectangular ring structure or a triangular ring structure. Alternatively, the first radiator 210 may be of an irregular ring structure. Specifically, the structure of the first radiator 210 may be selected and set based on a specific application scenario and design requirement. In this embodiment of this disclosure, an example in which the first radiator 210 is of a circular ring structure is used for description.

The second radiator 220 may be of a strip structure. For example, the second radiator 220 may be a part of the metal side frame 111 of the electronic device 100. For example, a length of the second radiator 220 may be determined based on a wavelength of an electromagnetic wave signal radiated by the second radiator 220, so that the corresponding length is cut on the metal side frame 111. Alternatively, the second radiator 220 may be a separately disposed mechanical part, and is attached to the middle frame 110 of the electronic device 100. For example, when the side frame of the electronic device 100 is a non-metal part, the length of the second radiator 220 may be designed based on a radiation wavelength of the second radiator 220, and the second radiator 220 is attached to the middle frame 110 of the electronic device 100. For example, the second radiator 220 may be attached to an inner side of the non-metal side frame 111, or may be attached to an outer side of the non-metal side frame 111.

Still referring to FIG. 4, the antenna structure 200 may further include a connection post 270. One end of the connection post 270 may be electrically connected to the first radiator 210. For example, the one end of the connection post 270 may be connected to an end that is of the first radiator 210 and that is close to the transmission line 230. The other end of the connection post 270 may be electrically connected to the second end of the transmission line 230, so that the first radiator 210 may be electrically connected to the second end of the transmission line 230 through the connection post 270. For example, the connection post 270 and the transmission line 230 may be disposed at an angle. For example, the connection post 270 and the transmission line 230 may be perpendicular to each other. When the first radiator 210 is located on the rear cover 130 of the electronic device 100, and the transmission line 230 is located on the metal middle plate 112 of the electronic device 100, there is a specific distance between the first radiator 210 and the metal middle plate 112. In this way, there is a specific distance between the transmission line 230 and the first radiator 210 in a thickness direction (namely, an x direction in FIG. 4) of the electronic device 100.

In this case, the connection post 270 is disposed between the transmission line 230 and the first radiator 210, one end of the connection post 270 is electrically connected to the first radiator 210, and the other end is electrically connected to the transmission line 230, so that the first radiator 210 can be electrically connected to the transmission line 230 through the connection post 270. In this way, the transmission line 230 can transmit electromagnetic energy to the first radiator 210 through the connection post 270. This helps improve rationality and reliability of a connection between mechanical parts in the electronic device 100, and improve rationality of a layout of the mechanical parts in the electronic device 100.

Still referring to FIG. 4, the antenna structure 200 may further include a ground post 280. One end of the ground post 280 may be electrically connected to the first radiator 210, and the other end of the ground post 280 may be electrically connected to the ground point 250. In this way, the first radiator 210 may be electrically connected to the ground point 250 through the ground post 280, and is electrically connected to the metal middle plate 112 in the electronic device 100 through the ground point 250. For example, the ground post 280 may be electrically connected to the ground point 250 through a metal spring, welding, or electrical coupling. The electromagnetic wave signal on the first radiator 210 may be transmitted to the ground point 250 through the ground post 280, and transmitted to the metal middle plate 112 of the electronic device 100 through the ground point 250, so that the electromagnetic wave signal can be radiated outward through the metal middle plate 112.

The ground post 280 may be electrically connected to any position on the first radiator 210. For example, the ground post 280 may be disposed at a position opposite to the connection post 270, as shown in FIG. 4. In this case, a position at which the ground post 280 is connected to the first radiator 210 and a position at which the connection post 270 is connected to the first radiator 210 are located in a diameter of the first radiator 210.

Alternatively, in some examples, a connection line between the ground post 280 and a center of the first radiator 210 and a connection line between the connection post 270 and the center of the first radiator 210 may be disposed at an angle. For example, an included angle between the two connection lines may be 60°, 90°, 120°, or the like. Specifically, the position at which the ground post 280 is connected to the first radiator 210 may be selected and set based on a specific structure of the electronic device 100 and a specific application scenario.

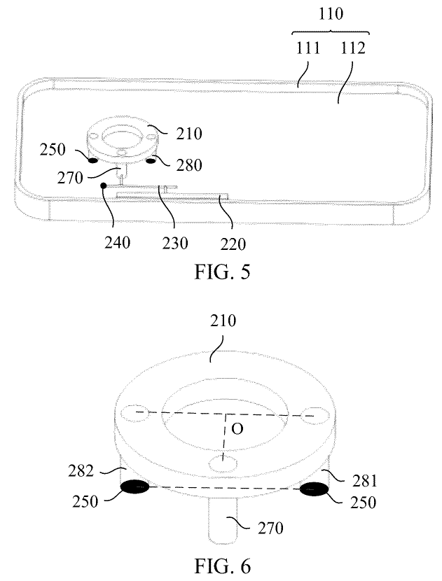

FIG. 5 is a diagram of a structure of a second type of antenna structure according to an embodiment of this disclosure. FIG. 6 is a diagram of a structure in which two ground posts are disposed on a first radiator according to an embodiment of this disclosure.

As shown in FIG. 5 and FIG. 6, in this embodiment of this disclosure, there may be two ground posts 280. For example, the two ground posts 280 may be a first ground post 281 and a second ground post 282. There may also be two ground points 250. One end of the first ground post 281 and one end of the second ground post 282 may be electrically connected to the first radiator 210, and the other end of the first ground post 281 and the other end of the second ground post 282 may be electrically connected to the two ground points 250 respectively. The electromagnetic wave signal on the first radiator 210 may be transmitted to the two ground points 250 through the first ground post 281 and the second ground post 282, and transmitted to the metal middle plate 112 through the two ground points 250, so that the electromagnetic wave signal can be radiated outward through the metal middle plate 112.

Alternatively, in some examples, there may be a plurality of ground posts 280. A quantity of ground posts 280 is not limited in embodiments of this disclosure. Specifically, the quantity of ground posts 280 may be selected and set based on a specific structure design and application scenario.

A connection line between the first ground post 281 and the second ground post 282 may pass through the center of the first radiator 210. Alternatively, in some examples, a connection line between the first ground post 281 and the center of the first radiator 210 and a connection line between the second ground post 282 and the center of the first radiator 210 may be disposed at an angle. For example, an included angle between the connection line between the first ground post 281 and the center of the first radiator 210 and the connection line between the second ground post 282 and the center of the first radiator 210 may be 60°, 90°, 120°, or the like. Specifically, positions at which the first ground post 281 and the second ground post 282 are disposed on the first radiator 210 may be selected and set based on an electromagnetic wave radiation requirement of the antenna structure 200 or a specific application scenario.

It should be noted that, in this embodiment of this disclosure, the connection line between the first ground post 281 and the second ground post 282 is a connection line between two points at which the first ground post 281 and the second ground post 282 are connected to the first radiator 210. In other words, the connection line between the first ground post 281 and the second ground post 282 is a line parallel to a plane on which the first radiator 210 is located, rather than an oblique connection line. Correspondingly, the connection line between the first ground post 281, the second ground post 282, and the center of the radiator is also a connection line parallel to the plane on which the first radiator 210 is located.

In this embodiment of this disclosure, still as shown in FIG. 6, the connection line between the two ground posts 280 in the antenna structure 200 may pass through the center of the first radiator 210, and the connection line is perpendicular to a connection line between the center of the first radiator 210 and a connection point between the first radiator 210 and the transmission line 230. In other words, the connection line between the two points at which the first ground post 281 and the second ground post 282 are connected to the first radiator 210 is perpendicular to a connection line between the center of the first radiator 210 and a point at which the connection post 270 is connected to the first radiator 210. In this way, regularity of distribution of the ground posts 280 and the connection post 270 on the first radiator 210 can be improved. This helps implement different working modes of the antenna, so that the antenna can meet different working requirements.

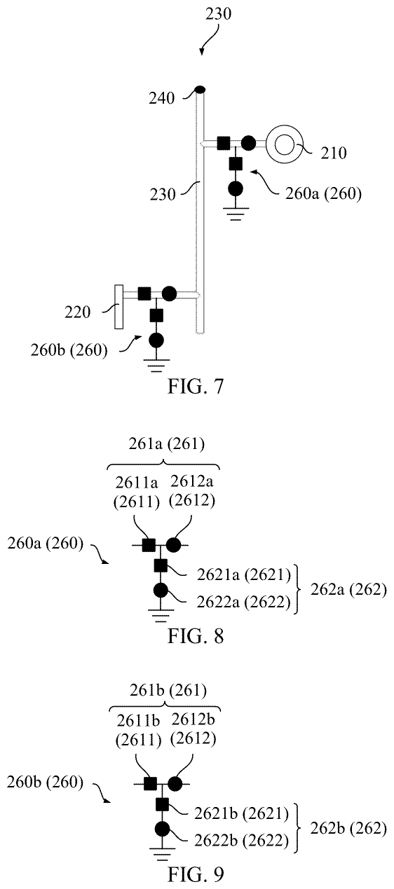

FIG. 7 is a diagram of a structure in which a matching circuit is disposed in an antenna structure according to an embodiment of this disclosure.

As shown in FIG. 7, the antenna structure 200 may further include two matching circuits 260. One end of one of the two matching circuits 260 may be electrically connected to the second end of the transmission line 230, and the other end may be electrically connected to the first radiator 210. One end of the other matching circuit 260 may be electrically connected to the second end of the transmission line 230, and the other end may be electrically connected to the second radiator 220. For example, as shown in FIG. 7, the two matching circuits 260 may be a matching circuit 260a and a matching circuit 260b respectively. One end of the matching circuit 260a may be electrically connected to the second end of the transmission line 230, and the other end of the matching circuit 260a may be electrically connected to the first radiator 210. One end of the matching circuit 260b may be electrically connected to the second end of the transmission line 230, and the other end may be electrically connected to the second radiator 220.

The matching circuits 260 may adjust the impedances of the first radiator 210 and the second radiator 220. For example, the matching circuit 260a may adjust the impedance of the first radiator 210, and the matching circuit 260b may adjust the impedance of the second radiator 220. In this way, the impedances of the first radiator 210 and the second radiator 220 in the single-pass states can be conjugated, and the load impedances can adapt to each other in a state in which the first radiator 210 and the second radiator 220 work simultaneously. In this way, the working modes of the first radiator 210 and the second radiator 220 can integrate, so that the radiation bandwidth of the electromagnetic wave signal is effectively increased, and the radiation intensity of the antenna structure 200 is increased.

FIG. 8 is a diagram of a structure of a matching circuit according to an embodiment of this disclosure. FIG. 9 is a diagram of a structure of another matching circuit according to an embodiment of this disclosure.

As shown in FIG. 8, each matching circuit 260 may include a first circuit 261, and the first circuit 261 may include at least one of a first inductor 2611 and a first capacitor 2612. In addition, when the first circuit 261 includes the first inductor 2611 and the first capacitor 2612, the first inductor 2611 and the first capacitor 2612 may be connected in series. One end of the first circuit 261 may be electrically connected to the second end of the transmission line 230, and the other end of the first circuit 261 may be electrically connected to the first radiator 210 or the second radiator 220.

For example, as shown in FIG. 8, the matching circuit 260a may include a first circuit 261a, and the first circuit 261a may include at least one of a first inductor 2611a and a first capacitor 2612a. In addition, when the first circuit 261a includes the first inductor 2611a and the first capacitor 2612a, the first inductor 2611a and the first capacitor 2612a may be connected in series. One end of the first circuit 261a may be electrically connected to the second end of the transmission line 230, and the other end may be electrically connected to the first radiator 210. Correspondingly, as shown in FIG. 9, the matching circuit 260b may include a first circuit 261b, and the first circuit 261b may include at least one of a first inductor 2611b and a first capacitor 2612b. In addition, when the first circuit 261b includes the first inductor 2611b and the first capacitor 2612b, the first inductor 2611b and the first capacitor 2612b may be connected in series. One end of the first circuit 261b may be electrically connected to the second end of the transmission line 230, and the other end may be electrically connected to the second radiator 220.

For example, the first circuit 261a adjusts the impedance of the first radiator 210. The first inductor 2611a and the first capacitor 2612a may adjust the impedance of the first radiator 210, for example, may change the imaginary part of the first radiator 210. In this way, the imaginary part of the impedance of the first radiator 210 in the single-pass state and the imaginary part of the impedance of the second radiator 220 in the single-pass state may be opposite numbers to each other. For example, in a debugging process, based on a specific situation, the first circuit 261a may include only the first inductor 2611a. In this case, it is equivalent to that a capacitive reactance of the first capacitor 2612a is zero. Alternatively, the first circuit 261a may include only the first capacitor 2612a. In this case, it is equivalent to that an inductive reactance of the first inductor 2611a is zero. Alternatively, in some examples, the first circuit 261a may include both the first inductor 2611a and the first capacitor 2612a. In this case, both an inductive reactance of the first inductor 2611a and a capacitive reactance of the first capacitor 2612a are greater than zero. Specifically, a value of the inductive reactance of the first inductor 2611a and a value of the capacitive reactance of the first capacitor 2612a may be selected and set based on a specific application scenario.

Correspondingly, the first inductor 2611b and the first capacitor 2612b in the first circuit 261b may adjust the impedance of the second radiator 220, to change a value of the imaginary part of the second radiator 220. In this way, the imaginary part of the impedance of the second radiator 220 in the single-pass state and the imaginary part of the impedance of the first radiator 210 in the single-pass state may be opposite numbers to each other. For example, the first circuit 261b may include only the first inductor 2611b. In this case, it is equivalent to that a capacitive reactance of the first capacitor 2612b is zero. Alternatively, the first circuit 261b may include only the first capacitor 2612b. In this case, it is equivalent to that an inductive reactance of the first inductor 2611b is zero. Alternatively, in some examples, the first circuit 261b may include both the first inductor 2611b and the first capacitor 2612b. In this case, both an inductive reactance of the first inductor 2611 and a capacitive reactance of the first capacitor 2612 are greater than zero. Specifically, a value of the inductive reactance of the first inductor 2611b and a value of the capacitive reactance of the first capacitor 2612b may be selected and set based on a specific application scenario.

Still referring to FIG. 8 and FIG. 9, each matching circuit 260 may further include a second circuit 262, and the second circuit 262 may include at least one of a second inductor 2621 and a second capacitor 2622. In addition, when the second circuit 262 includes the second inductor 2621 and the second capacitor 2622, the second inductor 2621 and the second capacitor 2622 may be connected in series. One end of the second circuit 262 may be electrically connected to the first circuit 261, and the other end may be grounded.

For example, as shown in FIG. 8, the matching circuit 260a may include a second circuit 262a, and the second circuit 262a may include at least one of a second inductor 2621a and a second capacitor 2622a. In addition, when the second circuit 262a includes the second inductor 2621a and the second capacitor 2622a, the second inductor 2621a and the second capacitor 2622a may be connected in series. One end of the second circuit 262a may be electrically connected to the first circuit 261a, and the other end may be grounded. For example, the other end of the second circuit 262a may be electrically connected to the metal middle plate 112 in the electronic device 100, to implement grounding of the second circuit 262a.

Correspondingly, as shown in FIG. 9, the matching circuit 260b may include a second circuit 262b, and the second circuit 262b may include at least one of a second inductor 2621b and a second capacitor 2622b. In addition, when the second circuit 262b includes the second inductor 2621b and the second capacitor 2622b, the second inductor 2621b and the second capacitor 2622b may be connected in series. One end of the second circuit 262b may be electrically connected to the first circuit 261b, and the other end may be grounded. For example, the other end of the second circuit 262b may be electrically connected to the metal middle plate 112 in the electronic device 100, to implement grounding of the second circuit 262b.

The second inductor 2621 and the second capacitor 2622 may implement impedance matching between the second circuit 262 and the metal middle plate 112, to improve efficiency of transmitting an electromagnetic wave signal between the second circuit 262 and the metal middle plate 112. The second circuit 262a is used as an example. Based on an impedance status between the second circuit 262a and the metal middle plate 112, the second circuit 262a may include only the second inductor 2621a. In this case, it is equivalent to that a capacitive reactance of the second capacitor 2622a is zero. Alternatively, the second circuit 262a may include only the second capacitor 2622a. In this case, it is equivalent to that an inductive reactance of the second inductor 2621a is zero. Alternatively, in some examples, the second circuit 262a may include both the second inductor 2621a and the second capacitor 2622a. In this case, both an inductive reactance of the second inductor 2621a and a capacitive reactance of the second capacitor 2622a are greater than zero. Specifically, a value of the inductive reactance of the second inductor 2621a and a value of the capacitive reactance of the second capacitor 2622a may be selected and set based on a specific application scenario.

Correspondingly, an impedance of the second circuit 262b may also be set based on an impedance of the metal middle plate 112. For example, the second circuit 262b may include only the second inductor 2621b. In this case, it is equivalent to that a capacitive reactance of the second capacitor 2622b is zero. Alternatively, the second circuit 262b may include only the second capacitor 2622b. In this case, it is equivalent to that an inductive reactance of the second inductor 2621b is zero. Alternatively, in some examples, the second circuit 262b may include both the second inductor 2621b and the second capacitor 2622b. In this case, both an inductive reactance of the second inductor 2621b and a capacitive reactance of the second capacitor 2622b are greater than zero. Specifically, a value of the inductive reactance of the second inductor 2621b and a value of the capacitive reactance of the second capacitor 2622b may be selected and set based on a specific application scenario.

It should be noted that there may be a plurality of specific positions at which the second circuit 262 is electrically connected to the first circuit 261. An electrical connection between the second circuit 262a and the second circuit 262a is used as an example. A position at which the second circuit 262a is connected to the first circuit 261a may be located between the first inductor 2611a and the first capacitor 2612a. Alternatively, a position at which the second circuit 262a is connected to the first circuit 261a may be located on a side that is of the first inductor 2611a and that faces away from the first capacitor 2612a. Alternatively, a position at which the second circuit 262a is connected to the first circuit 261a may be located on a side that is of the first capacitor 2612a and that faces away from the first inductor 2611a. A specific position at which the second circuit 262 is electrically connected to the first circuit 261 is not limited in this disclosure.

Correspondingly, for a position at which the second circuit 262b is connected to the first circuit 261b, refer to the position at which the second circuit 262a is connected to the first circuit 261a. Details are not described herein again.

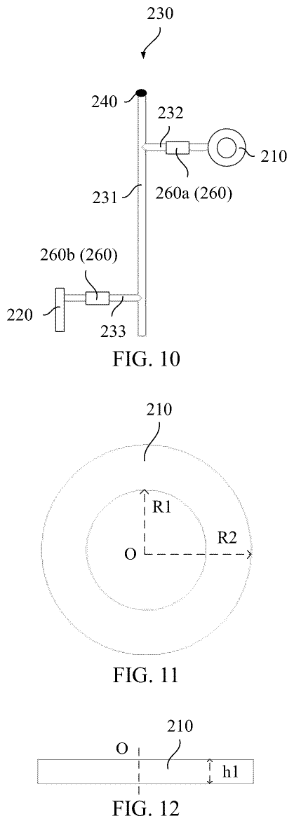

FIG. 10 is a diagram of a structure of the transmission line according to an embodiment of this disclosure.

As shown in FIG. 10, the transmission line 230 may include a main line 231, a first branch line 232, and a second branch line 233. The feed point 240 may be electrically connected to a first end of the main line 231. For example, the first end of the main line 231 may be electrically connected to the feed point 240 through a metal spring, welding, or electrical coupling, so that the feed point 240 can feed or input power to the transmission line 230 through the first end of the main line 231.

One end of the first branch line 232 may be electrically connected to a second end of the main line 231, and the other end of the first branch line 232 may be electrically connected to the first radiator 210, so that the first radiator 210 may be electrically connected to the main line 231 through the first branch line 232. For example, the first branch may be electrically connected to the connection post 270, so that the first branch may be electrically connected to the first radiator 210 through the connection post 270.

One end of the second branch line 233 may be electrically connected to the second end of the main line 231, and the other end of the second branch line 233 may be electrically connected to the second radiator 220, so that the second radiator 220 may be electrically connected to the main line 231 through the second branch line 233. In addition, the first branch line 232 and the second branch line 233 may be spaced apart along a length of the main line 231. For example, a spacing distance between the first branch line 232 and the second branch line 233 on the transmission line 230 may be determined based on specific positions of the first radiator 210 and the second radiator 220, to improve rationality of distribution of the first branch line 232 and the second branch line 233 on the main line 231.

The first end of the main line 231 may be understood as the first end of the transmission line 230, and the second end of the main line 231 may be understood as the second end of the transmission line 230.

The matching circuits 260 may be connected in series to the first branch line 232 and the second branch line 233 respectively. For example, as shown in FIG. 10, the matching circuit 260a may be connected in series to the first branch line 232. For example, the first inductor 2611a and the first capacitor 2612a in the matching circuit 260a may be connected in series to the first branch line 232. In this way, the matching circuit 260a may adjust the impedance of the first radiator 210 connected to the first branch line 232. The electromagnetic wave signal fed by the feed point 240 may be transmitted to the first radiator 210 through the matching circuit 260a on the first branch line 232, and radiated outward through the first radiator 210.

The matching circuit 260b may be connected in series to the second branch line 233. For example, the first inductor 2611b and the first capacitor 2612b in the matching circuit 260b may be connected in series to the second branch line 233. In this way, the matching circuit 260b may adjust the impedance of the second radiator 220 connected to the second branch line 233. The electromagnetic wave signal fed by the feed point 240 may be transmitted to the second radiator 220 through the matching circuit 260b on the second branch line 233, and radiated outward through the second radiator 220.

With reference to the accompanying drawings, in the following, a simulation test is performed on performance of the antenna structure 200 provided in this embodiment of this disclosure. For example, a size parameter of the antenna structure 200 may be input into a test system, to obtain a test result of the antenna structure 200. For example, a size of the first radiator 210, a size of the second radiator 220, sizes of the ground post 280 and the connection post 270, a size of the transmission line 230, and the like may be input into the test system, to obtain a performance parameter of the antenna through testing.

FIG. 11 is a main view of the first radiator according to an embodiment of this disclosure, and FIG. 12 is a top view of the first radiator according to an embodiment of this disclosure.

For example, as shown in FIG. 11 and FIG. 12, an inner diameter of the first radiator 210 may be R1, and a value of R1 may be 5 millimeters (mm); an outer diameter of the first radiator 210 may be R2, and a value of R2 may be 11.5 mm; and a thickness of the first radiator 210 may be h1, and a value of h1 may be 2.3 mm.

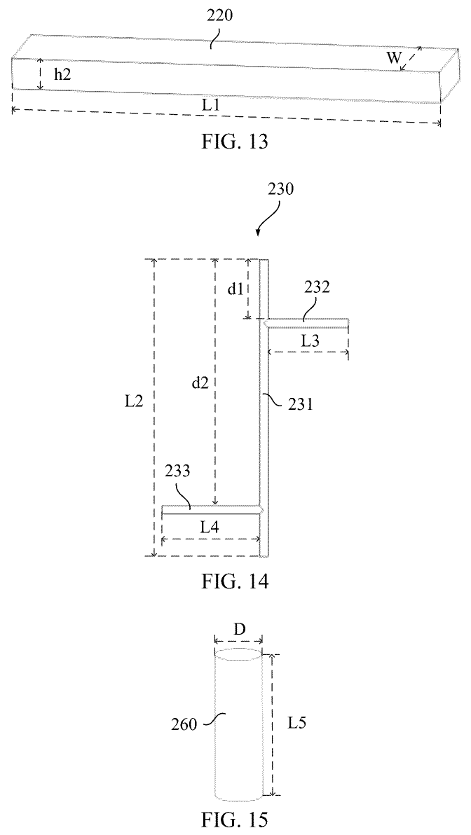

FIG. 13 is a diagram of a structure of the second radiator according to an embodiment of this disclosure.

As shown in FIG. 13, a length of the second radiator 220 of the strip structure may be L1, and a value of L1 may be 11.6 mm; a width of the second radiator 220 may be W, and a value of W may be 4.2 mm; and a height of the second radiator 220 may be h2, and a value of h2 may be 2.1 mm.

FIG. 14 is a diagram of the size of the transmission line according to an embodiment of this disclosure.

As shown in FIG. 14, a length of the main line 231 of the transmission line 230 may be L2, and a value of L2 may be 7.95 mm; a length of the first branch line 232 may be L3, and a value of L3 may be 1.1 mm; and a length of the second branch line 233 may be L4, and a value of L4 may be 0.7 mm. A distance between the first branch line 232 and an endpoint of the first end of the main line 231 may be d1, and a value of d1 may be 1.85 mm; and a distance between the second branch line 233 and the endpoint of the first end of the main line 231 may be d2, and a value of d2 may be 7.4 mm.

FIG. 15 is a diagram of a structure of the connection post according to an embodiment of this disclosure.

As shown in FIG. 15, a length of the connection post 270 may be L5, and a value of L5 may be 6.15 mm; and a diameter of the connection post 270 may be D, and a value of D may be 1.6 mm. A size of the ground post 280 may be the same as a size of the connection post 270. Details are not described herein again.

The foregoing size parameters of the antenna structure 200 are input into the test system, so that a diagram of a return loss and a diagram of antenna efficiency of the antenna structure 200 may be separately obtained.

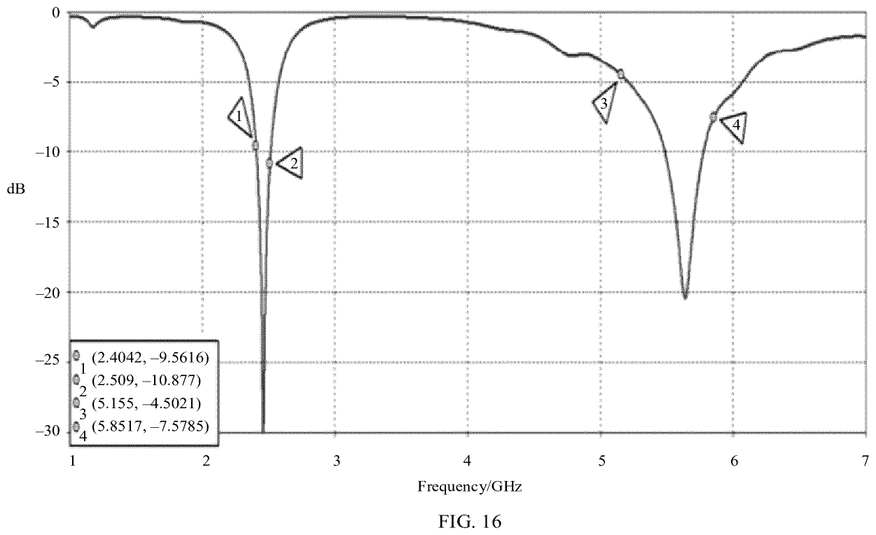

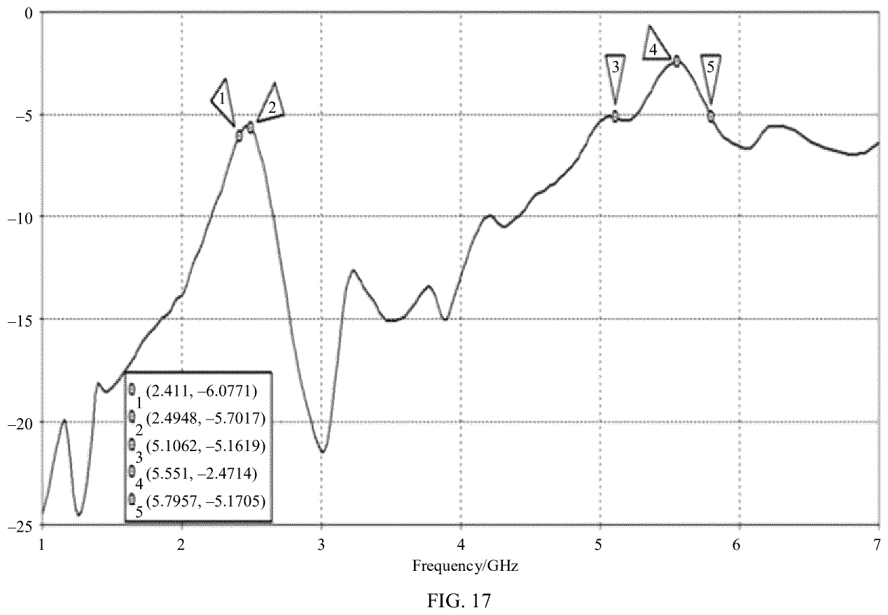

FIG. 16 is a diagram of a return loss of the first type of antenna structure according to an embodiment of this disclosure, and FIG. 17 is a diagram of radiation efficiency of the first type of antenna structure according to an embodiment of this disclosure.

FIG. 16 is a diagram (an S11 curve) of a return loss of the antenna when the antenna structure 200 includes one ground post 280. It can be learned from FIG. 15 that the antenna structure 200 has large electromagnetic wave return losses in two frequency bands: 2.4 gigahertz (GHz) to 2.5 GHz and 5.15 GHz to 5.85 GHz. This indicates that the antenna radiates most electromagnetic wave signals in 2.4 GHz to 2.5 GHz and 5.15 GHz to 5.85 GHz, and meets a bandwidth requirement of the antenna structure 200.

It should be noted that an S11 parameter may be a negative number. A smaller S11 parameter indicates a smaller return loss of the antenna, less energy reflected back by the antenna, namely, more energy that actually enters the antenna, and higher system efficiency of the antenna. A larger S11 parameter indicates a larger return loss of the antenna and lower system efficiency of the antenna. −6 decibels (dB) may be used as a value of S11. When a value of S11 of the antenna is less than −6 dB, it may be considered that the antenna can work normally, or it may be considered that transmit and receive efficiency of the antenna is good. Therefore, the antenna structure 200 provided in this embodiment of this disclosure has good transmit and receive efficiency at 2.4 GHz to 2.5 GHz and 5.15 GHz to 5.85 GHz.

FIG. 17 is a diagram of radiation efficiency of the antenna when the antenna structure 200 includes one ground post 280. It can be learned from FIG. 17 that the antenna structure 200 has good radiation efficiency in the two frequency bands: 2.4 GHz to 2.5 GHz and 5.15 GHz to 5.85 GHz, and meets a radiation efficiency indicator of the antenna.

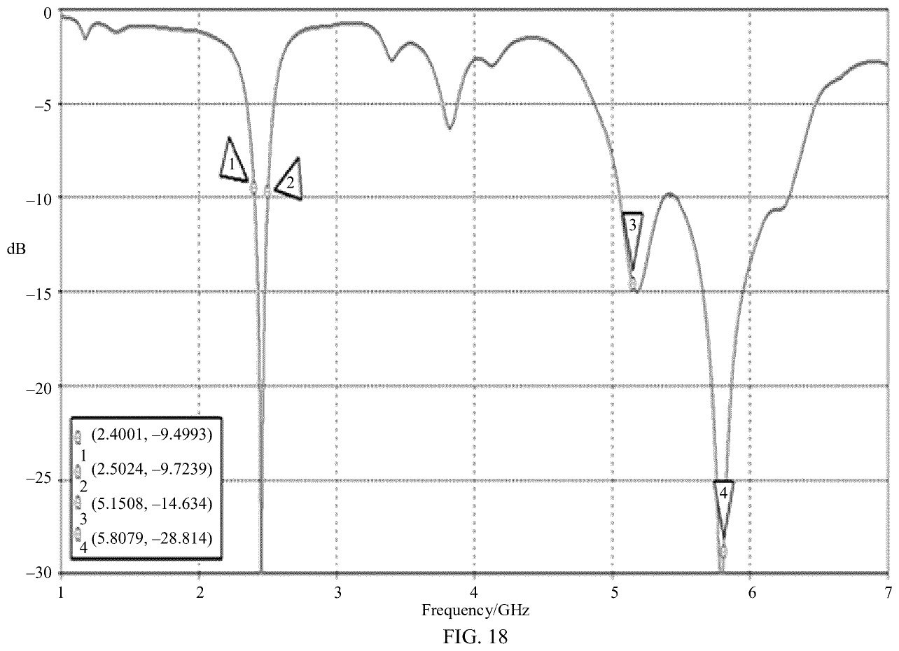

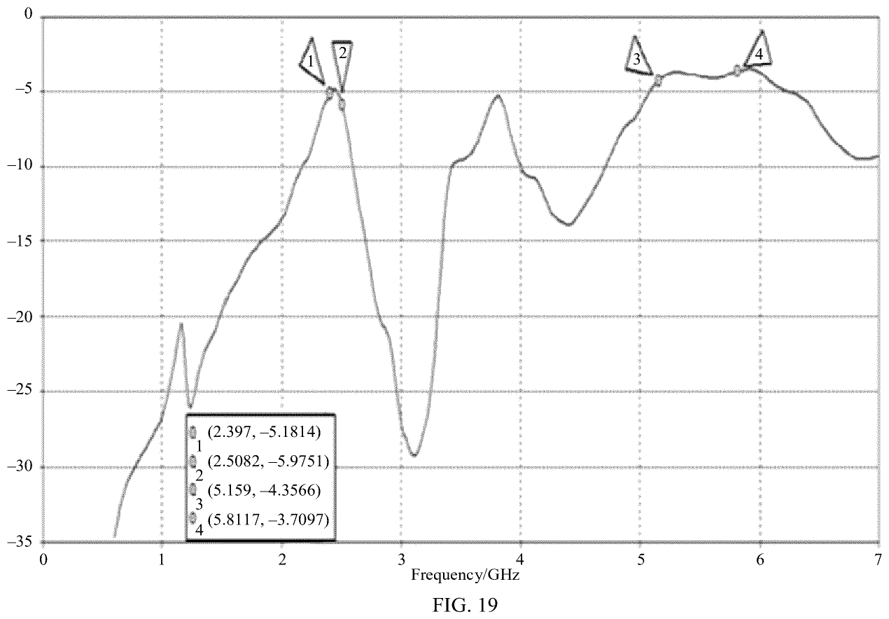

FIG. 18 is a diagram of a return loss of the second type of antenna structure 200 according to an embodiment of this disclosure, and FIG. 19 is a diagram of radiation efficiency of the second type of antenna structure 200 according to an embodiment of this disclosure.

FIG. 18 is a diagram of a return loss of the antenna when the antenna structure 200 includes two ground posts (the first ground post 281 and the second ground post 282). It can be learned from FIG. 18 that the antenna structure 200 has large electromagnetic wave return losses in two frequency bands: 2.4 GHz to 2.5 GHz and 5.15 GHz to 5.85 GHz. This indicates that the antenna radiates most electromagnetic wave signals in 2.4 GHz to 2.5 GHz and 5.15 GHz to 5.85 GHz, and meets a bandwidth requirement of the antenna structure 200.

FIG. 19 is a diagram of antenna efficiency when the antenna structure 200 includes two ground posts (the first ground post 281 and the second ground post 282). It can be learned from FIG. 19 that the antenna structure 200 has good radiation efficiency in the two frequency bands: 2.4 GHz to 2.5 GHz and 5.15 GHz to 5.85 GHz, and meets a radiation efficiency indicator of the antenna.

With reference to the accompanying drawings, in the following, impedance matching results of the first radiator 210 and the second radiator 220 in the single-pass states are tested. For example, the second radiator 220 may be disconnected from the transmission line 230, so that the feed point 240 at the first end of the transmission line 230 separately feeds the first radiator 210. In other words, the first radiator 210 is in the single-pass state. In this case, the Smith chart of the first radiator 210 may be obtained. For example, the second branch line 233 may be disconnected from the main line 231, so that the second radiator 220 is disconnected from the feed point 240 on the transmission line 230, and the electromagnetic energy at the feed point 240 may be separately transmitted to the first radiator 210 through the transmission line 230.

Correspondingly, the first radiator 210 may be disconnected from the transmission line 230, so that the feed point 240 at the first end of the transmission line 230 separately feeds the second radiator 220. In other words, the second radiator 220 is in the single-pass state. In this case, the Smith chart of the second radiator 220 may be obtained. For example, the first branch line 232 may be disconnected from the main line 231, so that the first radiator 210 is disconnected from the feed point 240 on the transmission line 230, and the electromagnetic energy at the feed point 240 may be separately transmitted to the second radiator 220 through the transmission line 230.

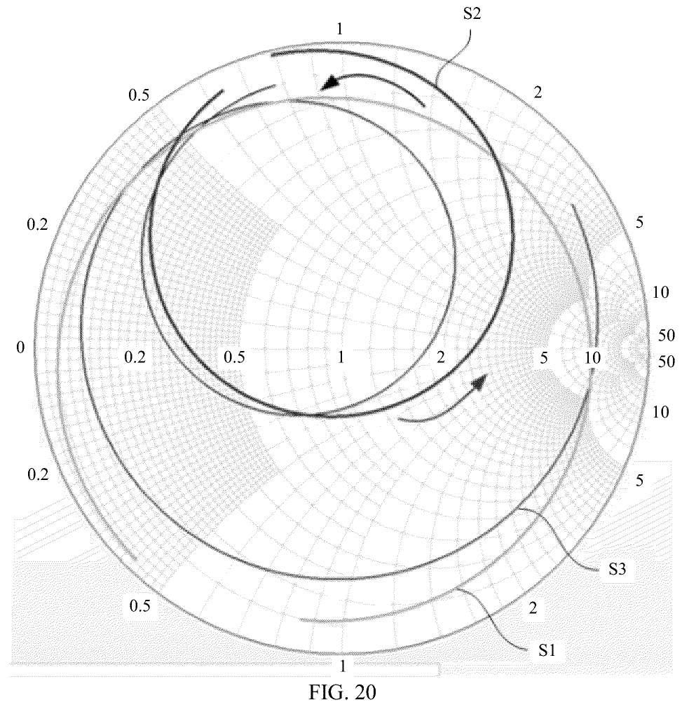

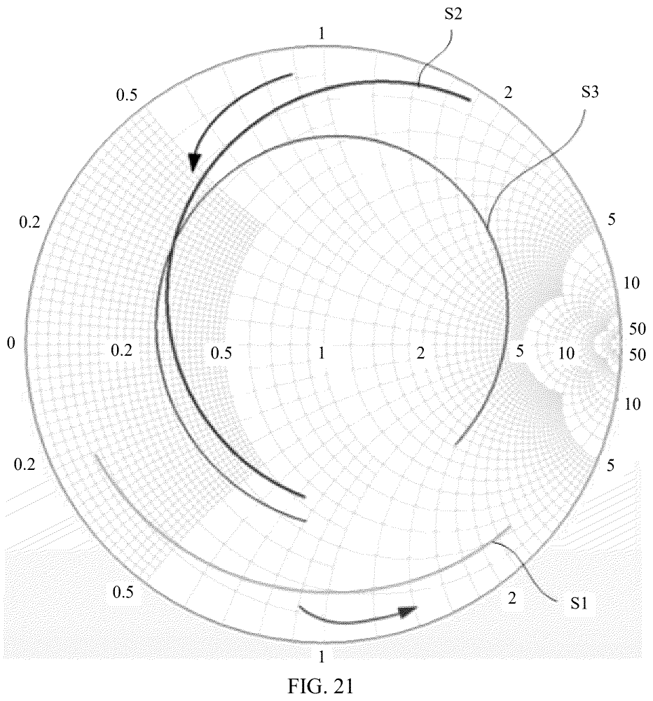

FIG. 20 is a Smith chart of the first radiator in the single-pass state according to an embodiment of this disclosure, and FIG. 21 is a Smith chart of the second radiator in the single-pass state according to an embodiment of this disclosure.

FIG. 20 is the Smith chart of the first radiator 210 in the single-pass state, and FIG. 21 is the Smith chart of the second radiator 220 in the single-pass state. In the figures, a curve S1 is a Smith chart curve of 2.4 GHz, a curve S2 is a Smith chart curve of 2.5 GHz, and a curve S3 is a Smith chart curve of another frequency band. It can be learned from the figures that the Smith chart curves of the first radiator 210 and the second radiator 220 in the single-pass states are mutually conjugated. In this way, when both the first radiator 210 and the second radiator 220 are electrically connected to the transmission line 230 to simultaneously radiate electromagnetic wave signals, the load impedances of the first radiator 210 and the second radiator 220 may adapt to each other, allowing their modes to integrate, to increase the radiation bandwidth of the electromagnetic wave signal. This effectively increases the radiation intensity of the antenna structure 200 in the wide frequency band.

In the descriptions of embodiments of this disclosure, it should be noted that, unless otherwise explicitly stipulated and restricted, the terms “mount”, “interconnect”, and “connect” should be understood in a broad sense. For example, a connection may be a fixed connection, or may be an indirect connection through an intermediate medium, or may be an internal communication between two components, or may be an interaction relationship between two components. A person of ordinary skill in the art may understand specific meanings of the foregoing terms in embodiments of this disclosure based on specific cases. The terms “first”, “second”, “third”, “fourth”, and the like (if existent) are intended to distinguish between similar objects but do not necessarily indicate a specific order or sequence.

Finally, it should be noted that the foregoing embodiments are merely used to describe the technical solutions in embodiments of this disclosure, but not to limit the technical solutions. Although embodiments of this disclosure are described in detail with reference to the foregoing embodiments, a person of ordinary skill in the art should understand that the technical solutions recorded in the foregoing embodiments may still be modified, or some or all of technical features thereof may be equivalently replaced. However, these modifications or replacements do not depart from the scope of the technical solutions in embodiments of this disclosure.

What is claimed is:

1. An antenna structure, comprising:
a first ground point;
a first radiator electrically connected to the first ground point and configured to have a first impedance when the antenna structure is operating in a first state;
a second radiator configured to have a second impedance when the antenna structure is operating in a second state, wherein the first impedance and the second impedance are conjugates;
a feed point; and
a transmission line comprising:
a first end electrically connected to the feed point; and
a second end electrically connected to the first radiator and the second radiator,
wherein the transmission line is configured to:
transmit first electromagnetic energy to the first radiator when the antenna structure is operating in the first state; and
transmit second electromagnetic energy to the second radiator when the antenna structure is operating in the second state.

2. The antenna structure of claim 1, further comprising:
a first matching circuit comprising:
a third end electrically connected to the second end; and
a fourth end electrically connected to the first radiator; and
a second matching circuit comprising:
a fifth end electrically connected to the second end; and
a sixth end electrically connected to the second radiator.

3. The antenna structure of claim 2, wherein the first matching circuit further comprises a first subcircuit, wherein the first subcircuit comprises:
a seventh end electrically connected to the second end;
an eighth end electrically connected to the first radiator or the second radiator; and
at least one of a first capacitor or a first inductor,
wherein the first capacitor and the first inductor are connected in series when the first subcircuit comprises the first inductor and the first capacitor, and
wherein the second matching circuit further comprises a second subcircuit comprising:
a ninth end electrically connected to the second end;
a tenth end electrically connected to the first radiator or the second radiator; and
at least one of a second capacitor or a second inductor,
wherein the second capacitor and the second inductor are connected in series when the second subcircuit comprises the second capacitor and the second inductor.

4. The antenna structure of claim 3, wherein the first matching circuit further comprises a third subcircuit, wherein the third subcircuit comprises:
an eleventh end electrically connected to the first subcircuit;
a twelfth end configured to be grounded; and
at least one of a third capacitor and a third inductor,
wherein the third capacitor and the third inductor are connected in series when the third subcircuit comprises the third inductor and the third capacitor, and
wherein the second matching circuit comprises a fourth subcircuit comprising:
a thirteenth end electrically connected to the first subcircuit;
a fourteenth end configured to be grounded; and
at least one of a fourth capacitor and a fourth inductor,
wherein the fourth capacitor and the fourth inductor are connected in series when the fourth subcircuit comprises the fourth capacitor and the fourth inductor.

5. The antenna structure of claim 2, wherein the transmission line further comprises:
a main line comprising:
the first end; and
the second end;
a first branch line comprising:
a first segment electrically connecting the third end to the second end; and
a second segment electrically connecting the third end to the second end; and
a second branch line comprising:
a third segment electrically connecting the fifth end to the second end; and
a fourth segment electrically connecting the sixth end to the second radiator,
wherein the first branch line and the second branch line are spaced apart along a length of the main line.

6. The antenna structure of claim 1, further comprising a connection post comprising:
a third end electrically connected to the first radiator; and
a fourth end electrically connected to the second end.

7. The antenna structure of claim 6, further comprising a first ground post, wherein the first ground post comprises:
a fifth end electrically connected to the first radiator; and
a sixth end electrically connected to the first ground point.

8. The antenna structure of claim 7, further comprising:
a second ground point; and
a second ground post comprising:
a seventh end electrically connected to the first radiator; and
an eighth end electrically connected to the second ground point.

9. The antenna structure of claim 8, wherein the fifth end and the seventh end define a first connection line connecting the fifth end and the seventh end, wherein a center of the first radiator and the third end define a second connection line connecting the center of the first radiator and the third end, and wherein the first connection line is perpendicular to the second connection line.

10. The antenna structure of claim 1, wherein the first radiator has a ring structure and the second radiator has a strip structure.

11. An electronic device, comprising:
a display;
a rear cover;
a middle frame located between the display and the rear cover; and
an antenna structure comprising:
a ground point;
a first radiator electrically connected to the ground point, configured to have a first impedance when the antenna structure is operating in a first state, and located on the rear cover;
a second radiator configured to have a second impedance when the antenna structure is operating in a second state and located on the middle frame, wherein the first impedance and the second impedance are conjugates;
a feed point; and
a transmission line comprising:
a first end electrically connected to the feed point; and
a second end electrically connected to the first radiator and the second radiator,
wherein the transmission line is configured to:
transmit first electromagnetic energy to the first radiator when the antenna structure is operating in the first state; and
transmit second electromagnetic energy to the second radiator when the antenna structure is operating in the second state.

12. The electronic device of claim 11, wherein the middle frame comprises a metal side frame comprising a part forming the second radiator of the antenna structure.

13. The electronic device of claim 12, wherein the middle frame further comprises a metal middle plate connected to the metal side frame, and wherein the ground point is electrically connected to the metal middle plate.

14. The electronic device of claim 11, further comprising a camera decorative part located on the rear cover, comprising metal, and forming the first radiator.

15. The electronic device of claim 11, wherein the antenna structure further comprises:
a first matching circuit comprising:
a third end electrically connected to the second end; and
a fourth end electrically connected to the first radiator; and
a second matching circuit comprising:
a fifth end electrically connected to the second end; and
a sixth end electrically connected to the second radiator.

16. The electronic device of claim 15, wherein the first matching circuit further comprises a first subcircuit comprising:
a seventh end electrically connected to the second end;
an eighth end electrically connected to the first radiator or the second radiator; and
at least one of a first capacitor or a first inductor,
wherein the first capacitor and the first inductor are connected in series when the first subcircuit comprises the first inductor and the first capacitor, and
wherein the second matching circuit further comprises a second subcircuit comprising:
a ninth end electrically connected to the second end;
a tenth end electrically connected to the first radiator or the second radiator; and
at least one of a second capacitor or a second inductor,
wherein the second capacitor and the second inductor are connected in series when the second subcircuit comprises the second capacitor and the second inductor.

17. The electronic device of claim 16, wherein the first matching circuit further comprises a third subcircuit, wherein the third subcircuit comprises:
an eleventh end electrically connected to the first subcircuit;
a twelfth end configured to be grounded; and
at least one of a third capacitor and a third inductor,
wherein the third capacitor and the third inductor are connected in series when the third subcircuit comprises the third inductor and the third capacitor, and
wherein the second matching circuit comprises a fourth subcircuit comprising:
a thirteenth end electrically connected to the first subcircuit;
a fourteenth end configured to be grounded; and
at least one of a fourth capacitor and a fourth inductor,
wherein the fourth capacitor and the fourth inductor are connected in series when the fourth subcircuit comprises the fourth capacitor and the fourth inductor.

18. The electronic device of claim 15, wherein the transmission line further comprises:
a main line comprising:
the first end; and
the second end;
a first branch line comprising:
a first segment electrically connecting the third end to the second end; and
a second segment electrically connecting the fourth end to the first radiator; and
a second branch line comprising:
a third segment electrically connecting the fifth end to the second end; and
a fourth segment electrically connecting the sixth end to the second radiator,
wherein the first branch line and the second branch line are spaced apart along a length of the main line.

19. The electronic device of claim 11, further comprising a connection post comprising:
a third end electrically connected to the first radiator; and
a fourth end electrically connected to the second end.

20. An electronic device, comprising:
a display;
a rear cover;
a middle frame located between the display and the rear cover; and
an antenna structure comprising:
a ground point;
a first radiator electrically connected to the ground point, configured to have a first impedance when the antenna structure is operating in a first state, and located between the middle frame and the rear cover;
a second radiator configured to have a second impedance when the antenna structure is operating in a second state and located on the middle frame, wherein the first impedance and the second impedance are conjugates;
a feed point; and
a transmission line comprising:
a first end electrically connected to the feed point; and
a second end electrically connected to the first radiator and the second radiator,
wherein the transmission line is configured to:
transmit first electromagnetic energy to the first radiator when the antenna structure is operating in the first state; and
transmit second electromagnetic energy to the second radiator when the antenna structure is operating in the second state.
